(19) United States
(12) Patent Application Publication
(10) Pub. No.: US 2017/0203422 A1
(43) Pub. Date: Jul. 20, 2017

(54) Adjustable Oil Filter Wrench

(71) Applicant: Ezaria Y. Markous, Royal Oak, MI (US)

(72) Inventor: Ezaria Y. Markous, Royal Oak, MI (US)

(21) Appl. No.: 15/403,310

(22) Filed: Jan. 11, 2017

Related U.S. Application Data
(60) Provisional application No. 62/278,497, filed on Jan. 14, 2016.

(51) Int. Cl. B25B 27/00; B25B 13/50; B25B 23/00; B25B 13/48

(52) U.S. Cl. CPC B25B 27/0042; B25B 13/481; B25B 13/5008; B25B 23/0007

(57) ABSTRACT

An oil filter wrench which has two main parts mounted together so as to be movable towards and away from each other. Each part has an acruate surface aligned with each other. A threaded drive rod has one end in a threaded hole in a side portion of one main part and passes through a clearance hole in a portion of the other main part, with a head engaging the other main part so as to move the parts toward or away from each other to grip or release to the filter. A wrenching feature on the head and of another wrenching feature the bottom of one of the main parts allow a conventional wrenching tool to drive the wrench to rotate the oil filter and to drive the drive element to move the main parts together to grip the filter oil apart to release the same. An extension rod is able to be engaged a wrenching feature on the bottom of said oil filter wrench to loosen or tighten the oil filter on its mounting.

### CROSS REFERENCE TO RELATED APPLICATIONS

This invention claims the benefit of U.S. provisional patent application No. 62/278,497 filed on Jan. 14, 2016.

### BACKGROUND OF THE INVENTION

This invention concerns oil filter wrenches adapted to tighten and loosen automotive oil filters, such as oil filters are mounted by being threaded onto a tube which receives circulated oil and are tightened to a specified degree against a sealing surface defined on the engine adjacent the threaded tube. Since oil filters are changed regularly as per the recommendations of the manufacturers, this is a very common maintenance operation and it is desirable that it be able to be carried out quickly and reliably so that no leakage occurs.

A proper degree of tightening is necessary to prevent leakage without damaging the filter, which requires the use of a wrenching tool to tighten the oil filter connection sufficiently and to remove the oil filter when it needs to be changed.

There are two primary factors affecting removal and installation of oil filters. Firstly filters are made in many different diameters and secondly space for movement of wrenching tools to loosen or tighten the oil filter is usually quite limited, particularly in a radial directions around the filter.

Another requirement is to be able to apply sufficient torque to the oil filter to be loosened and removed and to be tightened to the proper extent. This requires a tight engagement of the tool with the cylindrical body of the oil filter, often difficult to achieve when the filter is installed on the engine.

One approach is to use one of a set of cupped shaped pieces, which include various sides. Or to purchase each a size required, if the owner is changing the filter. There is a limit to how many sizes are practical, resulting in loose or too tight wrenches being used.

Various wrapping tools have been devised which are designed to grip a range of oil filter diameters, but these have required considerable space to be tightened, and may not effectively grip the oil filter if sufficient space is not available.

It is an object of the present invention to provide an oil filter wrench which accommodates a range of oil filter diameters while enabling a tight grip to be radially achieved with only a minimal radial space around the oil filter being necessary to tightly engage the oil filter either to loosen or tighten the same.

### SUMMARY OF THE INVENTION

The above recited object as well as other objects which will be understood by those skilled in the art are achieved by an oil filter wrench comprised of two main parts, mounted together so as to be movable relative each other, each part having a portion defining a concave filter gripper surface which face each other, and which are able to be moved towards and away from each other to enable gripping or loosening of an oil filter bodies of a range of different diameters.

This movement is carried out by a advancing a threaded rod extending through aligned holes in each of a lower section of the main parts move the two parts towards together to be tightened or away from each other to be loosened. One hole is threaded and receives a threaded end on the threaded rod so that a head on the other end of the adjustment screw is shifted while the screw advanced therein to bring the two parts closer together so as to grip the oil filter in order to tighten or loosen the oil filter.

The threaded rod has a head at one end formed with a wrenching feature such as a square recess able to receive a square drive on a ratchet wrench, with its handle extending down in an axial direction with respect to the oil filter. Only minimal swing of the handle is required to advance the adjustment screw in either direction, so that the possibility of interference with the surrounding components is loosened.

One of the main parts has a base plate extending radially across and beneath a slide plate on the other main part which is received in a guide slot fixed with respect to the base plate allowing movement of the concavely shaped portions of the two main parts towards and away from each other.

The undersurface of the base plate has a wrenching feature such as a square recess which can receive a tool with a mating feature, preferably a ratchet extension to not involve any swinging tool motion at a location near the oil filter, but only at a point well below the oil filter where sufficient clearance is to rotate the oil filter is usually present.

### DESCRIPTION OF THE DRAWING FIGURES

FIG. 1 is a pictorial view of an oil filter wrench according to an embodiment of the invention in an opened condition received over a lower end of an oil filter placed therein.

FIG. 2 is an inverted pictorial view of the oil filter wrench shown in FIG. 1 with an oil filter engaged by the arcuate gripper portions of the wrench.

FIG. 3 is a pictorial view of the oil filter wrench shown in FIGS. 1-2 with the oil filter omitted.

FIG. 4 is a view from the top of the oil filter wrench shown in FIGS. 1-3.

FIG. 5 is a view from one side of the oil filter wrench shown in FIGS. 1-4.

FIG. 6 is a view from another side of the oil filter wrench shown in FIGS. 1-4.

FIG. 7 is a top view of the oil filter wrench shown in FIGS. 1-5.

FIG. 8 is a pictorial view of one of the main parts of the oil filter wrench shown in FIGS. 1-7.

FIG. 9 is a pictorial view of the other of the main parts of the wrench according to the invention.

FIG. 10 is a side view of one main part.

FIG. 11 is a side view of the other main part.

### DETAILED DESCRIPTION

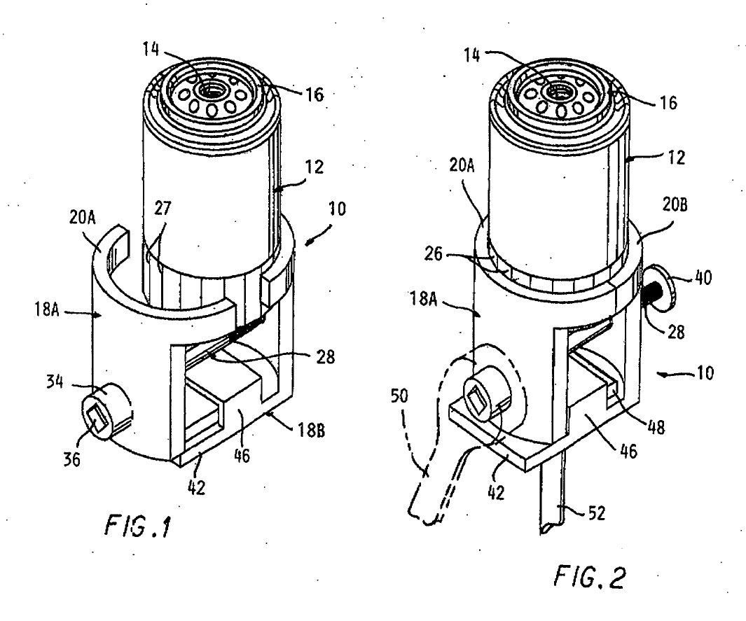

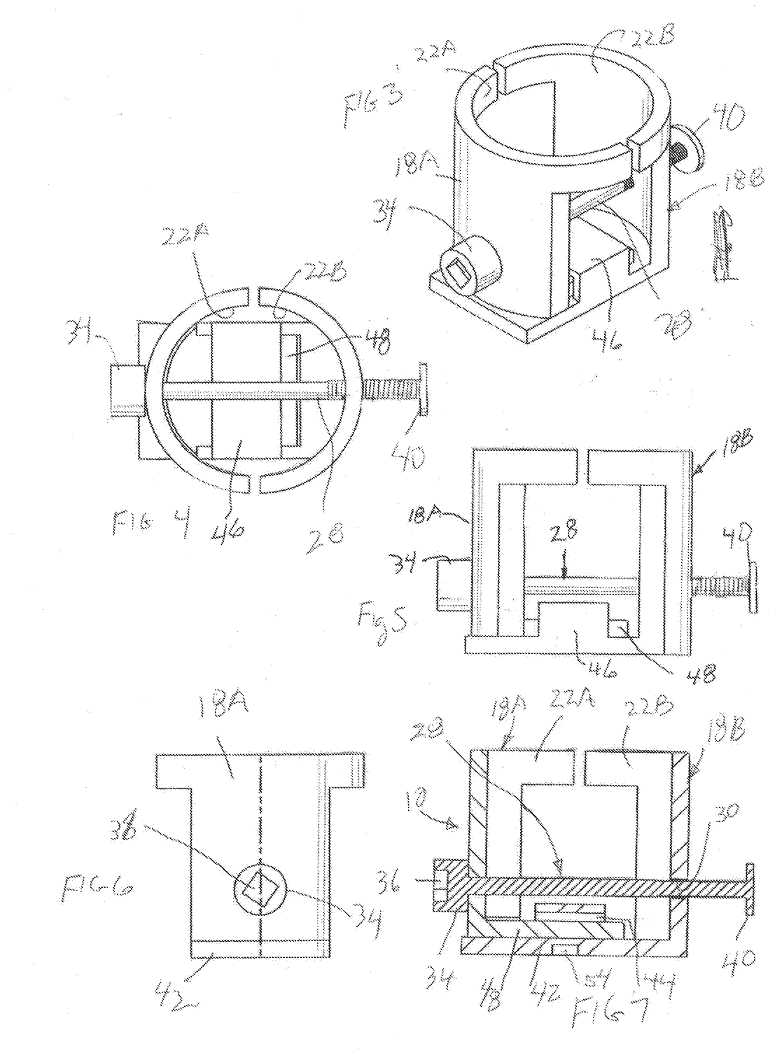

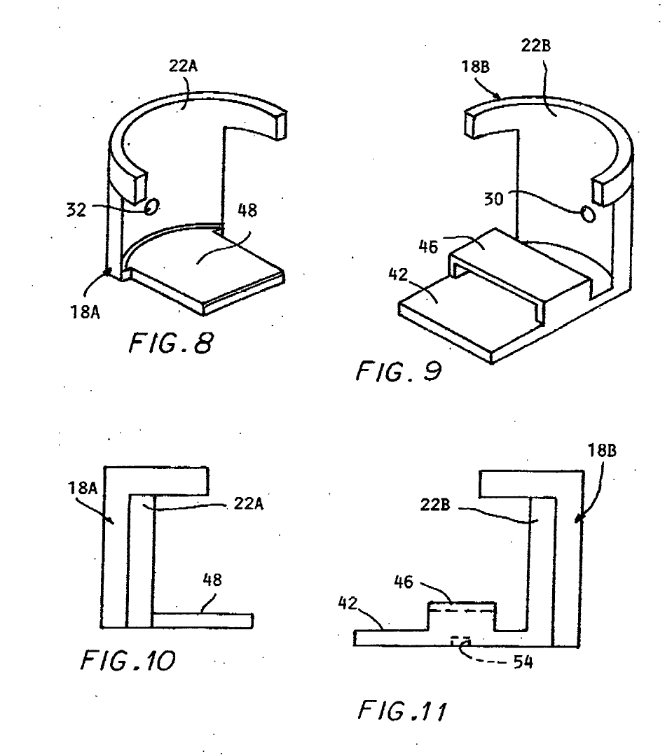

Referring to the drawings and particularly FIGS. 1 and 2, the oil filter wrench 10 according to the present invention is adapted to grip the bottom end of an automotive oil filter 12 which is installed on a vehicle engine, the wrench able to accommodate oil filters of a size over a substantial range of diameters of the oil filter 12.

Oil filters 12 are conventionally installed by being threaded onto a threaded tube (not shown) which receives circulation oil flow, received in a threaded hole 14 in the top of the oil filter. A gasket 16 engages a sealing surface (not shown), and is designed to be compressed to a proper degree by advancing of the oil filter on the threaded hole.

This usually requires more force than is able to be exerted by hand.

The oil filter wrench 10 according to the present invention is designed to tightly grip oil filters over a range of diameters thereof, and are able to be able to rotate the oil filter to achieve the proper tightness of fit when installed on the engine.

The oil filter wrench 10 is comprised of two main parts, 18A and 18B, which are interfit with each other to allow relative movement of arcuate concave surfaces formed on gripping portions 20A and 20B (FIG. 3) towards and away from each other.

The arcuate portions 20A, 20B each have a concave surface 22A, 22B facing each other so as to engage the exterior of an oil filter 12 when advanced towards each other.

The concave surfaces 22A, 22B do not necessarily have to be exactly matched to the lower exterior diameter 24 of the oil filter 20, which typically have a series of flats 26 creating peaks 27 to be engaged by the wrench surfaces 22A, 22B.

The relative adjusting movement between the two parts 18A and 18B is carried out by rotation of a threaded rod 28 having a threaded end received in a threaded hole 30 in main part 18B. The threaded rod 28 opposite end is passed through a clearance hole 32 in the main part 18A.

The opposite end of the rod 28 has a head 34 formed with a wrenching feature such as the square drive recess 36 as shown.

A flange 42 on the other end of the threaded rod 28 prevents complete disassembly of the wrench 10 to prevent the rod 28 from being separated and possibly last.

The movement of the two main parts 18A, 18B is guided so as to maintain alignment with each other by a base plate 42 formed on the main part 18B which has a guide slot 44 defined by a raised feature 46 projecting above the base plate 42.

The main part 18A has a slide plate 48 which slides on the upper surface of the plate 42 and through the slot 44 so as to maintain both main parts in proper alignment with each other.

In use, a ratchet wrench handle 50 can extend generally vertically to engage the drive feature 36 and move radially to the minimum extent necessary to rotate the threaded rod 28 and causing the concave surfaces 22A, 22B to be moved into firm gripping engagement with the sides of the oil filter 12.

A vertically extending extension rod 52 can be inserted into a second wrenching feature 54 such as a square drive opening 54 (FIG. 7) formed into the bottom of the base plate 42, the extensions 52 easily driven by a ratchet wrench to tighten or loosen the oil filter 12.

Thus tight engagement of the oil filter wrench 10 with the oil filter 12 is easily achieved with the oil filter 12 still in place on the engine.

Installation and removal of an oil filter 12 is facilitated by not requiring a lot of clearance space to tighten the wrench for removal of an old oil filter or installation of a new one.

1. An oil filter wrench comprising:
a pair of main parts each having concavely shaped engagement portions, said main parts slidably mounted together with said concave portions aligned and facing each other; an elongated threaded drive element having one end engaged in a threaded hole in one of said main parts, said drive element also passing through an aligned clearance hole in the other of said main parts but engageable with said other main part so as to be able to be advanced or retracted toward or away from each other can be so that said other main part can be advanced to said one main part in order to grip an oil filter disposed between said concave engagement services; and,
a wrenching feature on an under surface of said one or the other of said main parts enabling rotation thereof by a conventional wrenching tool having a handle extending axially away from an oil filter gripped by said concave surfaces.

2. The filter according to claim 1 wherein said drive feature on said drive element comprises a wrenching feature in a head of said drive element allowing engagement with a conventional ratchet socket wrench with a handle extending axially down and away from a bottom of said oil filter wrench.

3. The oil filter wrench according to claim 1 wherein a drive feature is formed on an undersurfaces of said oil filter wrench is engageable by an elongated extension rod extending axially away from said oil filter and engageble by a ratchet wrench to enable rotation of said oil filter to loosen or tighten the same.

4. The oil filter wrench according to claim 2 wherein said wrenching feature comprises a square recess in said oil filter wrench undersurface to tight or loosen an oil filter gripped by said oil filter wrench.

5. The oil filter wrench according to claim 3 wherein said drive feature on said drive element comprises a wrenching feature in a head on said drive element allowing engagement with a ratchet socket wrench having a handle extending axially down and away from said oil filter wrench.

6. The oil filter wrench according to claim 5 wherein said wrenching features comprise a square recess in said oil filter wrench undersurface.

7. The oil filter wrench according to claim 1 wherein said main parts are mounted together by a bottom plate projecting from a main part extending under a shorter plate extending from an opposite main part with a guide feature maintaining said bottom plate and said shorter plate in sliding engagement with each other as said main parts are moved relatively towards and away from each other.
